(19) United States
(12) Patent Application Publication
(10) Pub. No.: US 2005/0058586 A1
(43) Pub. Date: Mar. 17, 2005

(54) Method of converting nitrogen dioxide to nitric oxide

(75) Inventor: Philip C. Harris, Calgary (CA)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: Ametek, Inc.

(21) Appl. No.: 10/664,092

(22) Filed: Sep. 17, 2003

(51) Int. Cl. B01D 53/56; B01J 8/00; G01N 27/26

(52) U.S. Cl. 423/239.1; 204/426; 205/780.5

(57) ABSTRACT

A method of converting nitrogen dioxide to nitric oxide that includes passing a stream of gas containing nitrogen dioxide over a material that includes yttrium-stabilized zirconia. The method may be performed in a device for measuring NOₓ that includes a housing having a gas inlet and a gas outlet; a material that includes yttrium-stabilized zirconia positioned inside of the housing; a means for heating the surface of the material that includes yttrium-stabilized zirconia; and a means for measuring the amount of nitric oxide in a stream of gas that has passed over the material comprising yttrium-stabilized zirconia. The device may be used to measure the amount of NOₓ in a stream of gas by passing a stream of gas containing nitric oxide through the above-described inventive device.

### TECHNICAL FIELD OF THE INVENTION

The present invention relates to a method of converting nitrogen dioxide (NO₂) to nitric oxide (NO) and, in particular, using the method of converting NO₂ to NO in a device capable of determining the content of nitrogen oxides (NOₓ) in a gaseous stream, such as in environmental monitoring applications.

### BACKGROUND OF THE INVENTION

Nitric oxide and nitrogen dioxide are combustion by-products formed in numerous industrial processes. The sum of the concentration of these two species is referred to as nitrogen oxides, or NOₓ, and has been implicated in photochemical smog formation. NOₓ is a priority pollutant, and regulations exist which require facilities such as power generating stations, utility burners, and other combustion sources to both minimize and continuously monitor the release of NOₓ into the environment.

While it is possible to measure these species individually, the regulated measurement is the sum of the two species. As well, there exist more accurate and sensitive methods to continuously measure nitric oxide (NO) than nitrogen dioxide (NO₂). For these reasons, a means to convert nitrogen dioxide to nitric oxide has great practical utility in continuous emissions monitoring.

Many methods for converting nitrogen dioxide to nitric oxide have been proposed and used in industry. In its simplest form, nitrogen dioxide to nitric oxide conversion can be performed by purely thermal means in which the gas is heated above 800° C., and complete dissociation of nitrogen dioxide to nitric oxide occurs. Many developers of nitric oxide analyzers have felt that these elevated temperatures increased the size, cost, and complexity of NOₓ measurement devices, making a method of performing the nitrogen dioxide to nitric oxide conversion at lower temperatures highly desirable.

It is known that catalysts such as gold or platinum can be used to reduce the NO₂ to NO conversion temperature to the 670° C. to 750° C. range. U.S. Pat. No. 3,904,371 to Neti et al. discloses using copper oxides and/or vitreous carbon to act as a catalyst in promoting the decomposition of nitrogen dioxide at temperatures of 400° C. to 500° C. U.S. Pat. No. 3,979,501 to Stahl discloses using copper fines as a catalyst for NO₂ decomposition at temperatures of 220° C. to 240° C. U.S. Pat. No. 5,633,170 to Neti discloses the use of preconditioned vitreous carbon to convert nitrogen dioxide to nitric oxide at temperatures as low as 200° C. Others have relied on the chemical reaction between molybdenum oxide and nitrogen dioxide to reduce the nitrogen dioxide to nitric oxide.

In all of the above-mentioned methods of NO₂ decomposition, the converter has been thought of as an additional component that must be added to the system, thereby increasing complexity and cost. Moreover, many of the converters developed have been shown to have relatively low conversion efficiencies for the NO₂ to NO conversion.

Further, while NOₓ is a required measurement for many combustion applications, for pollution control reasons, oxygen is usually measured simultaneously for burner control and optimization. Thus, yet another detector is required to make the required measurements.

Therefore, there is an established need in the art for a method of converting NO₂ to NO at a relatively low temperature while minimizing the number and complexity of devices required to make NO and other required measurements.

### SUMMARY OF THE INVENTION

The present invention provides a method of converting nitrogen dioxide (NO₂) to nitric oxide (NO) comprising passing a stream of gas comprising nitrogen dioxide over a material comprising yttrium-stabilized zirconia.

The invention further provides a device for measuring nitrogen oxides (NOₓ) that includes a housing having a gas inlet, a gas outlet, a material that includes yttrium-stabilized zirconia positioned inside of the housing, and a means for heating the surface of the material that includes yttrium-stabilized zirconia; and a means for measuring the amount of nitric oxide in a stream of gas that has passed over the material comprising yttrium-stabilized zirconia.

The invention additionally provides a method of measuring the amount of NOₓ in a stream of gas that includes nitric oxide. The method includes the steps of passing a stream of gas containing nitric oxide through the above-described inventive device.

### DESCRIPTION OF THE DRAWINGS

FIG. 1 shows a schematic of a device of the present invention;

FIG. 2 is a graph showing the accuracy of a device according to the present invention at determining the varying levels of NOₓ in a gas stream; and

FIG. 3 is a graph showing the accuracy of a device according to the present invention at determining the varying levels of NOₓ in a gas stream.

### DETAILED DESCRIPTION OF THE INVENTION

Other than in the operating examples or where otherwise indicated, all numbers or expressions referring to quantities of ingredients, reaction conditions, etc., used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

As used herein, the term “substantially free” is meant to indicate that a material is present as an incidental impurity. In other words, the material is not intentionally added to an indicated composition, but may be present at minor or inconsequential levels because it was carried over as an impurity as part of an intended composition component.

In the present method, a stream of gas that includes NO₂ is passed over a material that includes yttrium-stabilized zirconia. Although yttrium-stabilized zirconia oxygen sensors have been applied to stack gas applications for a long time and have been shown to have excellent reliability in such applications, yttrium-stabilized zirconia has not heretofore been used to convert NO₂ to NO.

Any suitable material containing yttrium-stabilized zirconia may be used in the present invention. Suitable materials that contain yttrium-stabilized zirconia typically contain, as a majority component, ZrO₂, and as a minor component, Y₂O₃, and in some cases also contain minor amounts of HfO₂ Materials containing yttrium-stabilized zirconia may include at least 85 wt. %, in some cases at least 90 wt. %, and in other cases at least 92 wt. % ZrO₂. Also, the materials containing yttrium-stabilized zirconia may include up to 99 wt. %, in some cases up to 98 wt. %, and in other cases up to 97 wt. % ZrO₂. The amount of ZrO₂ in the materials containing yttrium-stabilized zirconia may vary between any of the values stated above. Additionally, the materials containing yttrium-stabilized zirconia may include at least 1 wt. %, in some cases at least 2 wt. %, and in other cases at least 3 wt. % Y₂O₃. Also, the materials containing yttrium-stabilized zirconia may include up to 8 wt. %, in some cases up to 10 wt. %, and in other cases up to 15 wt. % Y₂O₃. The amount of Y₂O₃ in the materials containing yttrium-stabilized zirconia may vary between any of the values stated above.

The material containing yttrium-stabilized zirconia can have any suitable shape that will allow for NO₂ to NO conversion. In an embodiment of the present invention, material containing yttrium-stabilized zirconia is cylindrical in shape. In another embodiment of the present invention, material containing yttrium-stabilized zirconia is planar in shape.

The material containing yttrium-stabilized zirconia can be substantially free of other materials. In an embodiment of the invention, the material containing yttrium-stabilized zirconia contains one or more oxides as an impurity. As used herein, the term “oxide” refers to any binary compound formed between an element and oxygen. Further to this embodiment, the oxides in the material containing yttrium-stabilized zirconia can include, but are not limited to, TiO₂, CaO, MgO, Al₂O₃, CuO, P₂O₅, SiO₂, Fe₂O₃, Cr₂O₃, and NiO₂. In a particular embodiment, the oxides in the material containing yttrium-stabilized zirconia are metal oxides and can include Al₂O₃, MgO, and CaO.

When oxides are present in the material containing yttrium-stabilized zirconia, they are present at a level of at least 0.001 wt. %, in some cases at least 0.01 wt. %, and in other cases at least 0.1 wt. %. Also, the material containing yttrium-stabilized zirconia can contain up to 2 wt. %, in some cases up to 1.5 wt. %, in other cases up to 1.0 wt. %, and in some situations up to 0.9 wt. % of oxides. In some instances, when the material containing yttrium-stabilized zirconia contains oxides, it has improved stability at high temperatures. The amount of oxides in the material containing yttrium-stabilized zirconia can vary between any value stated above.

When a stream of gas containing NO₂ is passed over the material containing yttrium-stabilized zirconia, the NO₂ is converted to NO. In an embodiment of the present invention, the surface temperature of the yttrium-stabilized zirconia may be at least 500° C., in some cases at least 600° C., and in other cases at least 650° C., and the surface temperature may be up to 900° C., in certain situations up to 800° C., in some cases up to 750° C., and in other cases up to 650° C. The surface temperature of the material containing yttrium-stabilized zirconia may vary between any of the stated temperatures. Typically, the surface temperature of the material containing yttrium-stabilized zirconia is high enough to provide greater than 99% conversion of NO₂ to NO. Thus, the total NOₓ (NO+NO₂) concentration in the stream of gas can be determined by measuring the amount of NO after passing the stream of gas over the material containing yttrium-stabilized zirconia.

In an embodiment of the present invention, the material that contains yttrium-stabilized zirconia can be platinum coated. In this embodiment, the oxygen content of the stream of gas may be determined by measuring the voltage difference or electromotive force (EMF) across the platinum-coated material comprising yttrium-stabilized zirconia, and applying the Nernst equation, which correlates chemical energy and electric potential.

In a particular embodiment of the present invention, the material containing yttrium-stabilized zirconia is fusion bonded with a layer of platinum.

As was indicated above, the use of yttrium-stabilized zirconia at elevated temperatures as an oxygen sensor is known; however, the use of such an oxygen sensor as the nitrogen dioxide to nitric oxide converter is novel. In the current invention, yttrium-stabilized zirconia is used to convert nitrogen dioxide to nitric oxide. The yttrium-stabilized zirconia may or may not have a platinum coating. If a platinum coating is applied to the material containing yttrium-stabilized zirconia, the assembly may be used as an oxygen analyzer or sensor simultaneous to its operation as a nitrogen dioxide to nitric oxide converter.

The analyzer or sensor is placed in a leakproof housing, which has a gas entry inlet and a gas exit outlet. The housing can be part of an insulated heating system for the platinum-coated yttrium-stabilized zirconia. A sample of gas that potentially contains nitrogen dioxide (and possibly nitric oxide) is allowed to flow through the housing at a flow rate of 0.2 to 2 liters per minute. While flowing through the cell, the nitrogen dioxide is decomposed to nitric oxide and oxygen. The nitric oxide can then be measured by a variety of suitable online means. Suitable online means include, but are not limited to, infrared photometry, ultraviolet absorption photometry, or chemiluminescence, and thereby determine the total NOₓ (NO+NO₂) concentration in the sample.

An embodiment of the invention is directed to a device for measuring NOₓ that includes a housing having a gas inlet, a gas outlet, the above-described material containing yttrium-stabilized zirconia positioned inside of the housing, and a means for heating the surface of the material comprising yttrium-stabilized zirconia. Additionally, a means for measuring the amount of nitric oxide in a stream of gas that has passed over the material comprising yttrium-stabilized zirconia is included in the device.

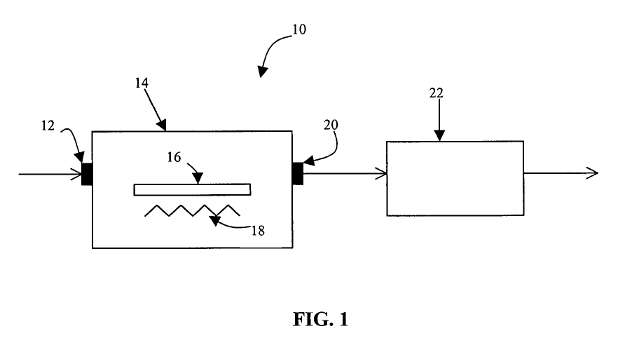

An embodiment of the device for measuring NOₓ is shown in FIG. 1. A device for measuring NOₓ 10, that includes a housing 14 having a gas inlet 12, a gas outlet 20, the above-described material containing yttrium-stabilized zirconia 16 positioned inside of housing 14, and a means for heating the surface of the material comprising yttrium-stabilized zirconia 18. As shown by the arrows, a stream of gas enters housing 14 via gas inlet 12 and passes over the material containing yttrium-stabilized zirconia 16 after which the gas stream exits housing 14 via gas outlet 20. The stream of gas then passes through a means for measuring the amount of nitric oxide 22 in the stream of gas.

In an alternative embodiment, the means for measuring the amount of nitric oxide 22 in the stream of gas can be positioned within housing 14.

Any suitable means for heating the surface of the material comprising yttrium-stabilized zirconia may be used in the present invention as long as it is capable of providing the desired temperatures and does not interfere with the operation of the device. A non-limiting example of a means for heating the surface of the material comprising yttrium-stabilized zirconia includes an electrical resistance heater.

In an embodiment of the present invention, the yttrium-stabilized zirconia is placed in an insulated enclosure that also contains an electrical resistance heater. The electrical resistance heater can transfer heat to the yttrium-stabilized zirconia by any suitable method including, but not limited to, conduction, convection, or radiative heat transfer. The temperature of the yttrium-stabilized zirconia can be measured using a resistance temperature device (RTD) or a thermocouple, and the measured temperature is used as a control variable in a feedback loop to maintain the yttrium-stabilized zirconia at a preset temperature determined to allow conversion of NO₂ to NO as described above.

Any suitable means for measuring the amount of nitric oxide in the stream of gas may be used in the present invention. Suitable means include those that provide a reliable measure of nitric oxide in the stream of gas. Suitable means for measuring the amount of nitric oxide in the stream of gas in the present invention include, but are not limited to, non-dispersive ultraviolet absorption spectroscopy, dispersive ultraviolet absorption spectroscopy, gas filter correlation ultra-violet (UV) spectroscopy, gas filter correlation infrared (IR) spectroscopy, non-dispersive infrared absorption spectroscopy, chemiluminescent reactions between ozone and nitric oxide, and NO specific sensors, a non-limiting example of which includes electrochemical cells as are known in the art.

In the device embodiment, the material comprising yttrium-stabilized zirconia is platinum coated. In this embodiment, the device does not need to include a separate means for measuring the oxygen content in the stream of gas because the amount of oxygen in the stream of gas can be determined by measuring the voltage difference across the platinum-coated material containing yttrium-stabilized zirconia. The device can be used in a method of measuring the amount of NOₓ in a stream of gas containing nitric oxide, whereby the a stream of gas containing nitric oxide is passed through the device.

### EXAMPLES

### Example 1

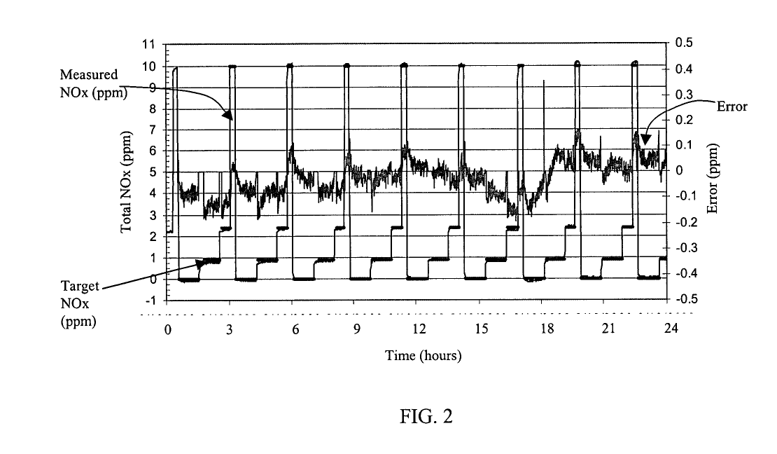

An Environics gas dilution system (Environics, Inc., Tolland, Conn.) was programmed to establish a varying target value of NOₓ concentration (as NO₂) in a reproducible manner in a stream of gas over a 24-hour period. The stream of gas was passed through the device described above and the NO concentrations in the stream of gas were measured using the above-described device with a non-dispersive UV analyzer. The analyzer was spanned at 10 ppm NOₓ, and the results recorded. These results are shown in FIG. 2. In general, the NOₓ accuracy was approximately +/−0.1 ppm NOₓ over the entire 24-hour period.

### Example 2

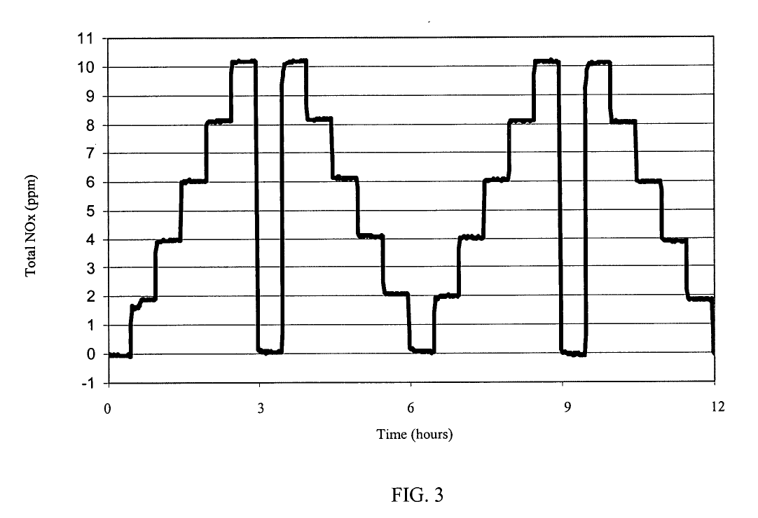

The equipment described in Example 1 was used to determine if there was any memory effect on the NOₓ converter of the present invention. The same type of varying NOₓ levels in a stream of gas were produced with increasing then decreasing concentrations, and were measured using the device as described in Example 1. The results are shown in FIG. 3, where the data shows excellent accuracy, repeatability, and conversion efficiency, and no signs of hysteresis in the present device.

The present invention has been described with reference to specific details of particular embodiments thereof. It is not intended that such details be regarded as limitations upon the scope of the invention except insofar as and to the extent that they are included in the accompanying claims.

1. A method of converting nitrogen dioxide to nitric oxide comprising passing a stream of gas comprising nitrogen dioxide over a material comprising yttrium-stabilized zirconia.

2. The method of claim 1, wherein the material comprising yttrium-stabilized zirconia comprises from 85 wt. % to 99 wt. % ZrO₂ and from 1 wt. % to 15 wt. % Y₂O₃.

3. The method of claim 1, wherein the material comprising yttrium-stabilized zirconia is platinum coated.

4. The method of claim 1, wherein the material comprising yttrium-stabilized zirconia is fusion bonded with a layer of platinum.

5. The method of claim 1, wherein the stream of gas is a stack gas stream.

6. The method of claim 1, wherein the stream of gas passes over the material comprising yttrium-stabilized zirconia at a rate of from 0.2 to 2 l/min.

7. The method of claim 1, wherein the yttrium-stabilized zirconia is cylindrical in shape.

8. The method of claim 1, wherein the yttrium-stabilized zirconia is planar in shape.

9. The method of claim 1, wherein the surface temperature of the yttrium-stabilized zirconia is from 500° C. to 900° C.

10. The method of claim 1, wherein the surface temperature of the yttrium-stabilized zirconia is from 650° C. to 700° C.

11. The method of claim 3, wherein the amount of oxygen in the stream of gas is determined by measuring the voltage difference across the platinum-coated material comprising yttrium-stabilized zirconia.

12. The method of claim 2, wherein the material comprising yttrium-stabilized zirconia further comprises from 0.001 to 2 wt. % of one or more other metal oxides.

13. The method of claim 12, wherein the other metal oxides comprise one or more selected from the group consisting of Al₂O₃, MgO, and CaO.

14. A device for measuring NOₓ comprising:
a. a housing having a gas inlet and a gas outlet;
b. a material comprising yttrium-stabilized zirconia positioned inside of the housing;
c. a means for heating the surface of the material comprising yttrium-stabilized zirconia; and
d. a means for measuring the amount of nitric oxide in a stream of gas that has passed over the material comprising yttrium-stabilized zirconia.

15. The device of claim 14, wherein the material comprising yttrium-stabilized zirconia is platinum coated.

16. The device of claim 15, wherein the device does not include a separate means for measuring the oxygen content in the stream of gas.

17. The device of claim 16, wherein the amount of oxygen in the stream of gas is determined by measuring the voltage difference across the platinum-coated material comprising yttrium-stabilized zirconia.

18. The device of claim 14, wherein the nitrogen dioxide in a stream of gas is converted to nitric oxide inside of the housing by allowing the stream of gas to pass over the material comprising yttrium-stabilized zirconia.

19. The device of claim 14, wherein the material comprising yttrium-stabilized zirconia is heated to a surface temperature of from 500° C. to 900° C.

20. The device of claim 14, wherein the material comprising yttrium-stabilized zirconia comprises from 85 wt. % to 99 wt. % ZrO₂ and from 1 wt. % to 15 wt. % Y₂O₃.

21. The device of claim 20, wherein the material comprising yttrium-stabilized zirconia further comprises from 0.001 to 2 wt. % of one or more other metal oxides.

22. The device of claim 21, wherein the other metal oxides comprise one or more selected from the group consisting of Al₂O₃, MgO, and CaO.

23. The device of claim 14, adapted to allow a stream of gas to enter the gas inlet.

24. The device of claim 23, wherein the stream of gas is a stack gas.

25. The device of claim 23, wherein the stream of gas passes over the material comprising yttrium-stabilized zirconia at a rate of from 0.2 to 2 l/min.

26. The device of claim 23, wherein the surface temperature of the yttrium-stabilized zirconia is from 650° C. to 700° C.

27. The device of claim 14, wherein the means for heating the surface of the material comprising yttrium-stabilized zirconia includes an electrical resistance heater.

28. The device of claim 14, wherein the means for measuring the amount of nitric oxide in a stream of gas includes one or more methods selected from the group consisting of non-dispersive ultraviolet absorption spectroscopy, dispersive ultraviolet absorption spectroscopy, gas filter correlation ultra-violet spectroscopy, gas filter correlation infrared spectroscopy, non-dispersive infrared absorption spectroscopy, chemiluminescent reactions between ozone and nitric oxide, and NO specific sensors.

29. The device of claim 28, wherein the NO specific sensors include electrochemical cells.

30. A method of measuring the amount of NOₓ in a stream of gas comprising nitric oxides, the method comprising passing a stream of gas comprising nitric oxides through a device comprising:
a. a housing having a gas inlet adapted to accept the stream of gas and a gas outlet for expelling the stream of gas from the housing;
b. a material comprising yttrium-stabilized zirconia positioned inside of the housing;
c. a means for heating the surface of the material comprising yttrium-stabilized zirconia; and
d. a means for measuring the amount of nitric oxide in the stream of gas that has passed over the material comprising yttrium-stabilized zirconia.

31. The method of claim 30, wherein the material comprising yttrium-stabilized zirconia is platinum coated.

32. The method of claim 31, wherein the device does not include a separate means for measuring the oxygen content in the stream of gas.

33. The method of claim 31, wherein the amount of oxygen in the stream of gas is determined by measuring the voltage difference across the platinum-coated material comprising yttrium-stabilized zirconia.

34. The method of claim 30, wherein the material comprising yttrium-stabilized zirconia is heated to a surface temperature of from 500° C. to 900° C.

35. The method of claim 30, wherein the material comprising yttrium-stabilized zirconia comprises from 85 wt. % to 99 wt. % ZrO₂ and from 1 wt. % to 15 wt. % Y₂O₃.

36. The method of claim 35, wherein the material comprising yttrium-stabilized zirconia further comprises from 0.001 wt. % to 2 wt. % of one or more other metal oxides.

37. The method of claim 36, wherein the other metal oxides comprise one or more selected from the group consisting of Al₂O₃, MgO, and CaO.

38. The method of claim 30, wherein the stream of gas is a stack gas.

39. The method of claim 30, wherein the stream of gas passes over the material comprising yttrium-stabilized zirconia at a rate of from 0.2 to 2 l/min.

40. The method of claim 30, wherein the surface temperature of the yttrium-stabilized zirconia is from 650° C. to 700° C.

41. The method of claim 30, wherein the amount of nitric oxide in the stream of gas is determined by a method selected from the group consisting of infrared photometry, ultraviolet absorption photometry, and chemiluminescence.

42. The method of claim 30, wherein the means for heating the surface of the material comprising yttrium-stabilized zirconia in the device includes an electrical resistance heater.

43. The method of claim 30, wherein the means for measuring the amount of nitric oxide in a stream of gas in the device includes one or more methods selected from the group consisting of non-dispersive ultraviolet absorption spectroscopy, dispersive ultraviolet absorption spectroscopy, gas filter correlation ultra-violet spectroscopy, gas filter correlation infrared spectroscopy, non-dispersive infrared absorption spectroscopy, chemiluminescent reactions between ozone and nitric oxide, and NO specific sensors.

44. The method of claim 43, wherein the NO specific sensors include electrochemical cells.
